(19) United States
(12) Patent Application Publication
(10) Pub. No.: US 2016/0125402 A1
(43) Pub. Date: May 5, 2016

(54) METHOD AND DEVICE FOR PAYMENT USING TOKEN

(71) Applicant: SAMSUNG SDS CO., LTD., Seoul (KR)

(72) Inventors: Jin Seong LEE, Seoul (KR); Hee Jin PARK, Seoul (KR); Seung Hyun LEE, Seoul (KR); Weon Young YOUN, Seoul (KR); Tae Hun KIM, Seoul (KR)

(73) Assignee: SAMSUNG SDS CO., LTD., Seoul (KR)

(21) Appl. No.: 14/927,603

(22) Filed: Oct. 30, 2015

(30) Foreign Application Priority Data
Oct. 31, 2014 (KR) 10-2014-0149848

(51) Int. Cl. G06Q 20/38; G06Q 20/10; G06Q 20/36

(52) U.S. Cl. CPC G06Q 20/3825; G06Q 20/367; G06Q 20/3829; G06Q 20/38215; G06Q 20/10

(57) ABSTRACT

Methods and devices for payment using token are provided, one of methods comprises, receiving a public key and a payment device token from a payment device, creating a digital signature through encryption of the payment device token and a stored user token using the public key, and payment request data including the digital signature, transmitting the payment request data to the payment device and updating the user token through performing of a token update operation.

### CROSS-REFERENCE TO RELATED APPLICATION

This application is based on and claims priority from Korean Patent Application No. 10-2014-0149848, filed on Oct. 31, 2014 in the Korean Intellectual Property Office, the disclosure of which is incorporated herein in its entirety by reference.

### BACKGROUND

1. Field of the Invention

The present invention relates to a method and a device for payment using a token. More particularly, the present invention relates to a method and a device for payment, which enable a mobile device to make payment using a token in a non-secure element environment.

2. Description of the Prior Art

NFC (Near Field Communication) is a kind of non-contact type short-range wireless communication technology that can perform data transmission within a distance of about 10 cm using 13.56 MHz frequency band, and has recently been utilized in diverse service fields, such as payment, account transfer, name card exchange, product information providing, and coupon/advertisement providing.

On the other hand, as a means for authenticating or controlling a user of a mobile device without using a secure element, there is a method using a token. However, in the case where the mobile device has been copied and the original mobile device requests a token to make payment, the same coupon is also received in the copied mobile device, and thus a user of the copied mobile device may maliciously double-spend the token.

### PATENT DOCUMENT

Korean Patent Application Publication No. 2014-0088675

### SUMMARY

Accordingly, the present invention has been made to solve the above-mentioned problems occurring in the prior art, and one subject to be solved by the present invention is to provide a method and a device for payment, which can newly update a token that is stored in a mobile device whenever the mobile device requests payment.

Another subject to be solved by the present invention is to provide a method for payment and a device for performing the method, which can newly update a token that is stored in a payment server whenever payment is requested from a mobile device.

Still another subject to be solved by the present invention is to provide a method for payment and a device for performing the method, which can transmit a warning message if payment is requested from a copied mobile device.

Additional advantages, subjects, and features of the invention will be set forth in part in the description which follows and in part will become apparent to those having ordinary skill in the art upon examination of the following or may be learned from practice of the invention.

In some embodiments, a method for payment comprises, receiving a public key and a payment device token from an payment device, creating a digital signature through encryption of the payment device token and a stored user token using the public key, and creating payment request data including the digital signature, transmitting the payment request data to the payment device and updating the user token through performing of a token update operation.

In some embodiments, a method for payment comprises, transmitting a public key and a stored first payment device token to a first mobile device in response to a first payment request that is received from the first mobile device, receiving payment request data from the mobile device, transmitting the payment request data to a payment server, receiving a second payment device token from the payment server in response to transmission of the payment request data, and replacing the first payment device token by the second payment device token and transmitting, in response to a second payment request that is received from the first mobile device or a second mobile device, the public key and the second payment device token to the device that has transmitted the second payment request.

In some embodiments, a method for payment comprises, receiving payment request data from an payment device, verifying a digital signature that is included in the payment request data using a private key determining whether a payment device token and a user token that are included in the payment request data match with a stored payment device token and a stored user token, respectively, executing payment when the payment device token and the user token match with the stored payment device token and the stored user token, respectively, as the result of the determination and updating the stored payment device token and the stored user token through performing of a token update operation when the payment device token and the user token match with the stored payment device token and the stored user token, respectively.

In some embodiments, a method for payment comprises, transmitting, at a payment device, a public key and a payment device token that is stored in the payment device to a mobile device, creating, at the mobile device, a digital signature through encryption of the payment device token and a user token that is stored in the mobile device using the public key, and creating payment request data including the digital signature to transmit the created payment request data to the payment device, according to the created payment request data is transmitted, transmitting, at the payment device, the payment request data to a payment server and verifying, at the payment server, the digital signature included in the payment request data using a private key, and determining whether the payment device token and a user token included in the payment request data match with the payment device token stored in the payment request data and the stored user token, respectively, executing, at the payment server, payment when the payment device token and the user token match with the stored payment device token and the stored user token, respectively, as the result of the determination, and updating the payment device token stored in the payment server and the user token stored in the payment server through performing of a token update operation, receiving, at the payment device, the updated payment device token from the payment server, and replacing the payment device token stored in the payment device by the received payment device token and updating, at the mobile device, the user token stored in the mobile device through performing of the token update operation.

In some embodiments, a system for payment comprises, a mobile device creating a digital signature through encryption of a received payment device token and a stored user token using a received public key, creating payment request data including the digital signature, and updating the stored user token through performing of a token update operation, a payment device transmitting the public key and the stored payment device token to the mobile device, receiving the payment request data from the mobile device, receiving the updated payment device token, and replacing the stored payment device token by the received payment device token and a payment server receiving the payment request data from the payment device, verifying the digital signature of the payment request data using a private key, determining whether a payment device token and a user token that are included in the payment request data match with the stored payment device token and the stored user token, respectively, executing payment when the payment device token and the user token match with the stored payment device token and the stored user token, respectively, as the result of the determination, and updating the stored payment device token and the stored user token through performing of the token update operation.

According to the present invention as described above, since a stored token is newly updated whenever a mobile device requests payment, double spending of the token for payment can be prevented.

Further, since a warning message is transmitted if payment is requested from a copied mobile device, a user of the mobile device can confirm that his/her mobile device has been copied.

### BRIEF DESCRIPTION OF THE DRAWINGS

The above and other objects, features and advantages of the present invention will be more apparent from the following detailed description taken in conjunction with the accompanying drawings, in which:

FIG. 1 is a diagram illustrating the configuration of a payment system using a token according to an embodiment of the present invention;

FIG. 2 is a flowchart explaining a method for payment of a mobile device according to an embodiment of the present invention;

FIG. 3 is a flowchart explaining a method for payment of an payment device according to an embodiment of the present invention;

FIG. 4 is a flowchart explaining a method for payment of a payment server according to an embodiment of the present invention;

FIG. 5 is a signal flowchart explaining a method for payment using a token according to an embodiment of the present invention;

FIG. 6 is a signal flowchart in the case where a first mobile device makes prepayment according to an embodiment of the present invention;

FIG. 7 is a signal flowchart in the case where a first mobile device makes post-payment according to an embodiment of the present invention;

FIG. 8 is a diagram illustrating the logical configuration of a mobile device according to an embodiment of the present invention;

FIG. 9 is a diagram illustrating the logical configuration of an payment device according to an embodiment of the present invention;

FIG. 10 is a diagram illustrating the logical configuration of a payment server according to an embodiment of the present invention; and

FIG. 11 is a diagram illustrating the logical configuration of a mobile device, an payment device, and a payment server according to another embodiment of the present invention.

### DETAILED DESCRIPTION OF THE EMBODIMENTS

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims Like reference numerals refer to like elements throughout the specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, preferred embodiments of the present invention will be described in detail with reference to the accompanying drawings.

First, terms used in the description are defined.

Public key: Key that is used to encrypt a document in an asymmetric cryptosystem. The public key may have reciprocal relation to a private key.

Digital signature: Security technology for guaranteeing integrity of data that is transmitted through a network and a user who has created or transmitted the corresponding data. Digital signature, which is encrypted by a public key of a receiver that is open to the public, is created and attached to a message to be transmitted, and the receiver decrypts the received digital signature with receiver's own private key and then verifies the decrypted digital signature through comparison with the original message. The digital signature according to an embodiment of the present invention may be encrypted using any one of encryption algorithms, such as an RSA (Ron Rivest, Adi Shamir, and Leonard Adleman) algorithm, a DSA (Digital Standard Algorithm), an MD5 (Message-Digest algorithm 5), and an AES (Advanced Encryption Standard (AES), but is not limited thereto.

Token: Data that is used to control user authentication and use right. Token according to an embodiment of the present invention may be divided into a user token for authenticating the user of the mobile device and a terminal token for authenticating a payment device.

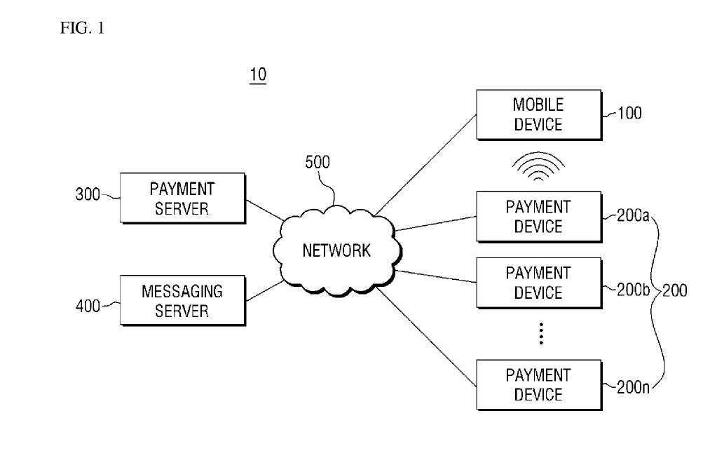

Hereinafter, referring to FIG. 1, the configuration of a payment system using a token according to an embodiment of the present invention will be described.

FIG. 1 is a diagram illustrating the configuration of a payment system 10 using a token according to an embodiment of the present invention. As illustrated in FIG. 1, a payment system 10 according to an embodiment of the present invention may include a mobile device 100, a device 200 for payment, a payment server 300, a messaging server 400, and a network 500.

Referring to FIG. 1, the mobile device 100 is a device for requesting payment from the payment device 200 using an NFC. The mobile device 100 may transmit/receive data with the payment device 200 using the NFC, and any device can be permitted as the mobile device 100 so far as it can update a user token whenever payment is requested. For example, the mobile device 100 according to an embodiment of the present disclosure may be any one of electronic devices, such as a smart phone, a tablet, a laptop, a PMP (Portable Multimedia Player), a phablet, a PDP (Personal Digital Assistants), and an e-book reader, but is not limited thereto.

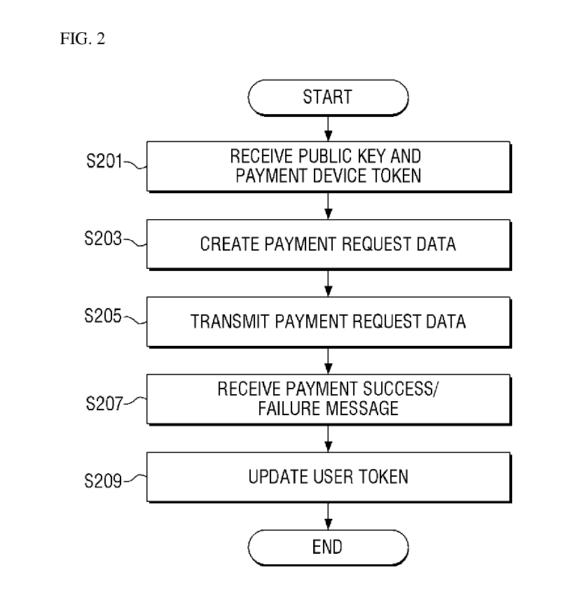

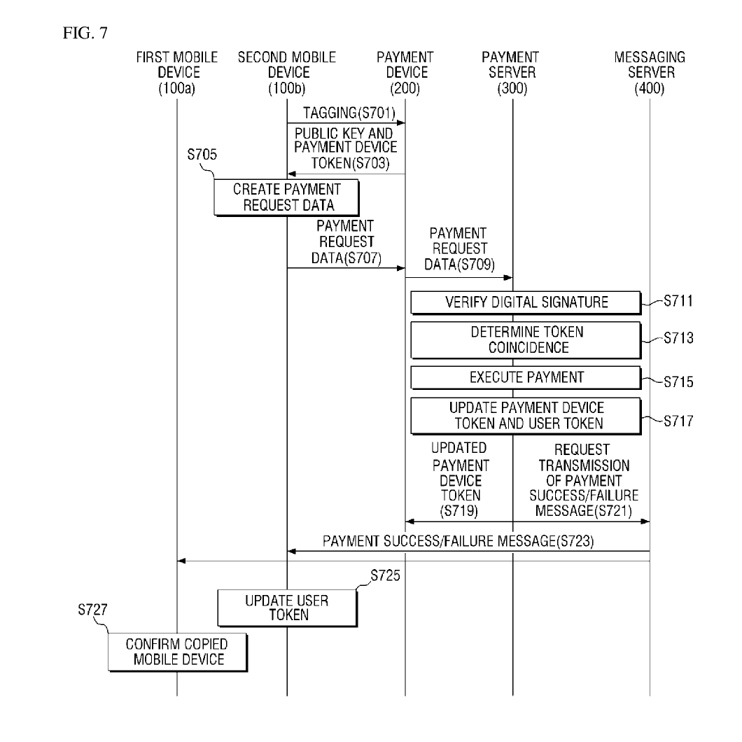

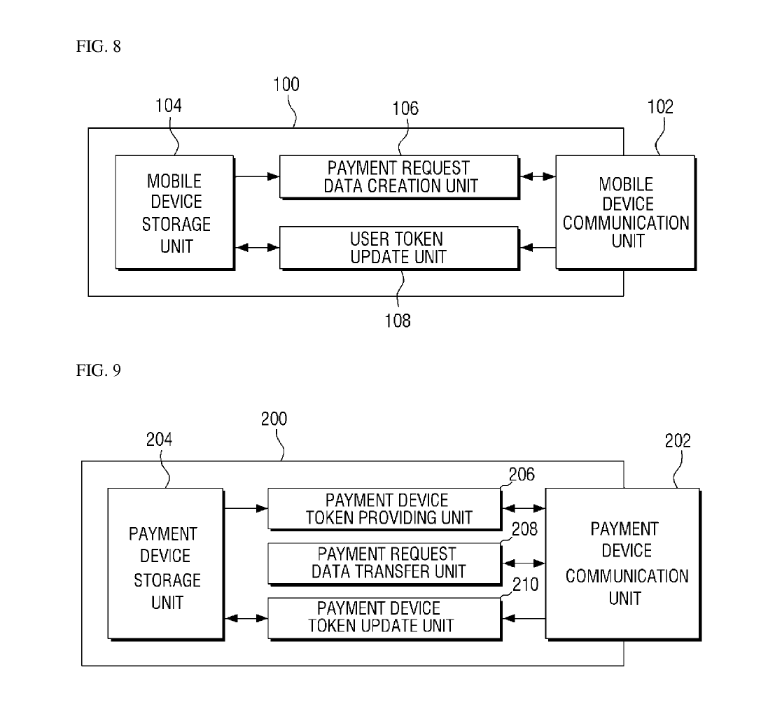

A method for payment of the mobile device 100 according to an embodiment of the present invention will be described in detail later with reference to FIG. 2, and the logical configuration of the mobile device 100 will be described in detail later with reference to FIG. 8.

The payment device 200 is to process the payment that is requested from the mobile device 100 using the payment server 300. The payment device 200 may transmit/receive data with the mobile device 100 using the NFC, transmit/receive data with the payment server 300 through the network 500, and update a payment device token. Preferably, the payment device 200 according to an embodiment of the present invention may be a POS (Point Of Sales) terminal, but is not limited thereto. The payment device 200 may also be a desktop or a laptop.

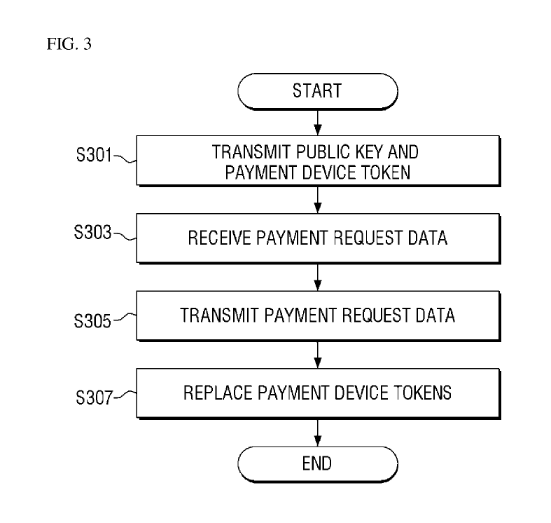

A method for payment of the payment device 200 according to an embodiment of the present invention will be described in detail later with reference to FIG. 3, and the logical configuration of the payment device 200 will be described in detail later with reference to FIG. 9.

The payment server 300 is a server for making the payment in accordance with the payment request from the payment device 200. The payment server 300 may transmit/receive data with the payment device 200 and the messaging server 400 through the network 500, make the payment, and update the user token and the payment device token. In particular, the payment server 300 according to an embodiment of the present invention can determine whether double spending of the token has been made using the user token and the payment device token.

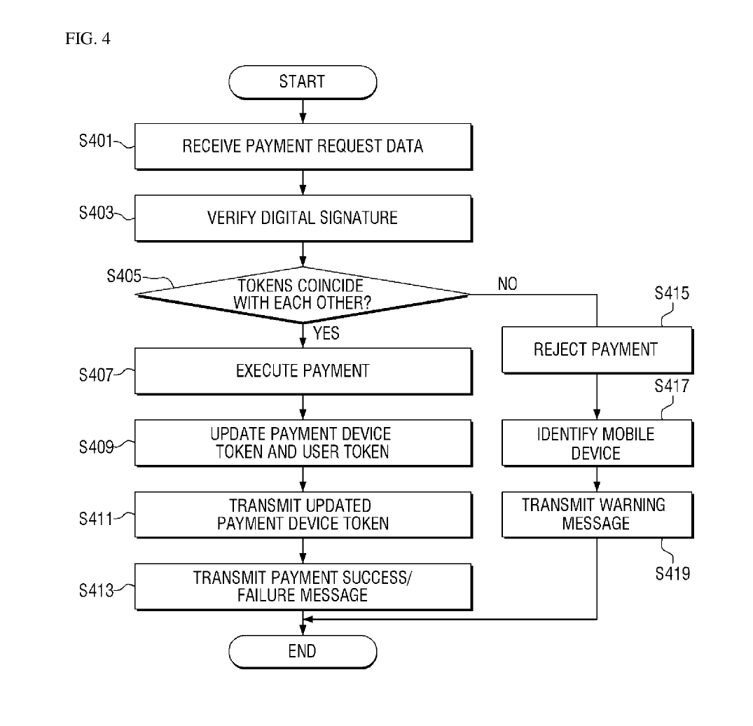

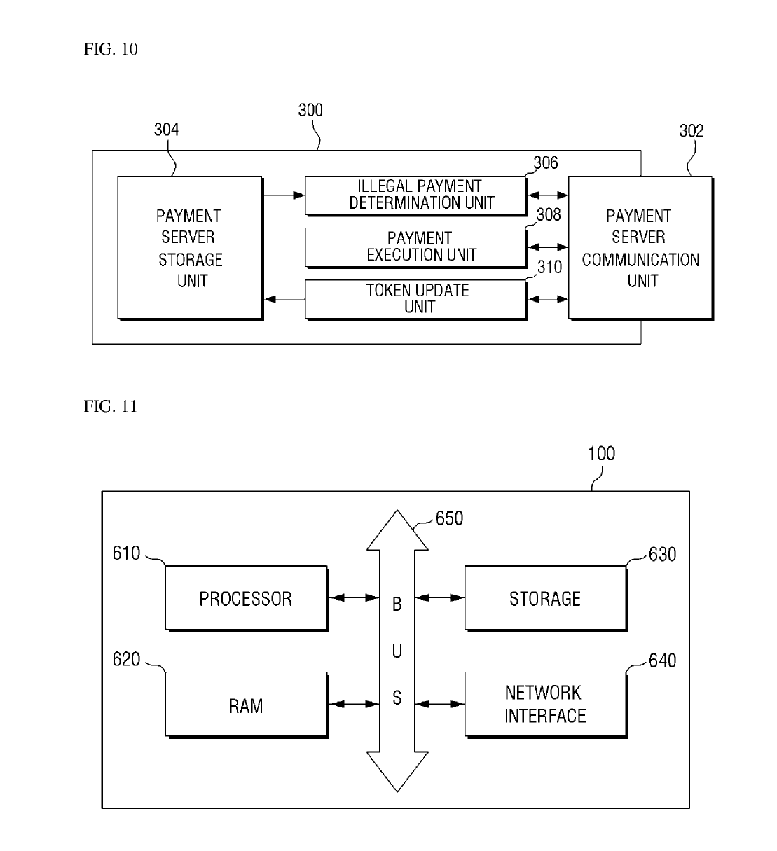

A method for payment of the payment server 300 according to an embodiment of the present invention will be described in detail later with reference to FIG. 4, and the logical configuration of the payment server 300 will be described in detail later with reference to FIG. 10.

The messaging server 400 may receive a payment success/failure message transmission request or a warning message transmission request from the payment server 300, and transmit a payment success/failure message or a warning message to the mobile device 100 through the network 500. Preferably, the message server 400 according to an embodiment of the present invention may transmit the message to the mobile device 100 in a push manner.

The network 500 is an infra(structure) for transmitting/receiving data among the mobile device 100, the payment device 200, the payment server 300, and the messaging server 400. The network 500 according to an embodiment of the present invention may be a communication network that is composed of one or more of a mobile communication network, such as CDMA (Code Division Multiple Access), WCDMA (Wideband CDMA), HSPA (High Speed Packet Access), or LTE (Long Term Evolution), a wired communication network, such as Ethernet, xDSL (x Digital Subscriber Line), HFC (Hybrid Fiber Coax), or FTTH (Fiber To The Home), and an NFC network, such as Wi-Fi, Wibro, or Wimax.

Hereinafter, a method for payment using a token according to an embodiment of the present invention will be described in detail with reference to FIGS. 2 to 4.

FIG. 2 is a flowchart explaining a method for payment of a mobile device 100 according to an embodiment of the present invention.

Referring to FIG. 2, if a user requests payment from a device 200 for payment through NFC tagging, a mobile device 100 receives a public key and a payment device token from a device 200 for payment using the NFC (S201).

The mobile device 100 creates a digital signature through encrypting the payment device token that is received at S201 and a user token that is stored in the mobile device 100 using the public key that is received at S201, and creates payment request data that includes the created digital signature (S203). In particular, the mobile device 100 may encrypt a time stamp that indicates a payment request time using the public key that is received at S201 and make the encrypted time stamp further included in the digital signature.

The mobile device 100 transmits the payment request data that is created at S203 to the payment device 200 (S205). Preferably, the mobile device 100 transmits the payment request data using the NFC, but is not limited thereto. The mobile device 100 may also transmit the payment request data through a network 500.

The mobile device 100 receives a payment success/failure message from a payment server 300 through a messaging server 400 (S207). Here, if the payment that is requested from the mobile device 100 is approved, the payment success/failure message may include a phrase indicating that the payment has been approved and deposit balance after the payment, whereas if the payment is rejected, the payment success/failure message may include a phrase indicating that the payment has been rejected and a phrase indicating the reason of the rejection.

If the payment success/failure message is received at S207, the mobile device 100 updates the user token that is stored in the mobile device 100 through performing of a token update operation (S209).

At S209, the token update operation that is performed by the mobile device 100 to update the user token is composed of a merge operation and a mapping operation. The merge operation and the mapping operation that are performed by the mobile device 100 are as follows.

The mobile device 100 performs the merge operation for deriving one resultant value through performing of a predetermined operation using the payment device token and the user token. Here, the predetermined operation may be a binary operation, such as addition, subtraction, multiplication, or division, in which the payment device token and the user token are considered as operands, but is not limited thereto. Further, in the case where the time stamp that is encrypted at S203 is further included in the digital signature, the mobile device 100 may perform the merge operation further using the time stamp as the operand of the predetermined operation.

Next, the mobile device 100 performs the mapping operation, in which a hash value that is mapped on the resultant value that is derived through the merge operation using a hash function is set as a new user token. Here, the hash function may use a secure hash algorithm, such as SHA-0, SHA-1, SHA-256, or SHA-512, but is not limited thereto.

If payment is requested from the payment device 200, the mobile device 100 according to an embodiment of the present invention may newly update the user token using the payment device token and the user token. Accordingly, even if the mobile device 100 is copied, the user token of the copied mobile device is different from the user token of the original mobile device, and thus it becomes possible to reject the payment request from the copied mobile device.

FIG. 3 is a flowchart explaining a method for payment of a device 200 for payment according to an embodiment of the present invention.

Referring to FIG. 3, if payment is requested from a mobile device 100 through NFC tagging, a device 200 for payment transmits a public key and a payment device token that is stored in the payment device 200 to the mobile device using the NFC (S301).

The payment device 200 receives payment request data from the mobile device 100 in response to S301 (S303). Preferably, the payment device 200 receives the payment request data using the NFC, but is not limited thereto. The payment device may also receive the payment request data through a network 500.

The payment device 200 transmits the payment request message that is received at S303 to a payment server 300 through the network 500 (S305).

Further, the payment device 200 updates the payment device token by receiving an updated payment device token from the payment server 300 and replacing the payment device token that is stored in the payment device 200 by the received updated payment device token (S307).

If payment is requested from the mobile device 100, the payment device 200 according to an embodiment of the present invention may update the stored payment device token through reception of the updated payment device token from the payment server 300. Accordingly, even if the mobile device 100 is copied, the copied mobile device is unable to use the payment device token that is used by the original mobile device to update the user token.

FIG. 4 is a flowchart explaining a method for payment of a payment server 300 according to an embodiment of the present invention.

Referring to FIG. 4, a payment server 300 receives payment request data from a device 200 for payment through a network 500 (S401).

The payment server 300 verifies a digital signature that is included in payment request data received at S401 using a private key (S403). Here, the private key is a key that has reciprocal relation to a public key that is used by the mobile device 100 to encrypt a payment device token and a user token.

The payment server 300 determines whether a payment device token and a user token, which are included in the payment request data that is received at S401, respectively match with a payment device token and a user token, which are stored in the payment server 300 (S405).

If the payment device token included in the payment request data matches with the payment device token stored in the payment server 300 and the user token included in the payment request data matches with the user token stored in the payment server 300 as the result of the determination at S405, the payment server 300 determines that the payment request of the mobile device 100 is not a double-payment request and performs the followings.

The payment server 300 executes payment (S407). Here, the payment server 300 may approve or reject the payment through collective determination of conditions for establishing transactions, such as deposit balance of a user account of the mobile device 100, effectiveness of a transaction means, and effectiveness of a transaction time.

The payment server updates the payment device token and the user token that are stored in the payment server 300 through performing of a token update operation (S409). In particular, according to another embodiment of the present invention, the payment server 300 may store the user token in an update list before performing S409.

At S409, the token update operation that is performed by the payment server 300 to update the payment device token and the user token is composed of a merge operation and a mapping operation. The merge operation and the mapping operation that are performed by the payment server 300 are as follows.

The payment server 300 performs the merge operation for deriving one resultant value through performing of a predetermined operation using the payment device token and the user token. Here, the predetermined operation may be a binary operation, such as addition, subtraction, multiplication, or division, in which the payment device token and the user token are considered as operands, but is not limited thereto. In particular, in the case of updating the payment device token and in the case of updating the user token, the payment server 300 may perform the merge operation by differently performing the predetermined operation.

Further, in the case where a time stamp is further included in payment request data, the payment server may perform the merge operation further using the time stamp that is included in the payment request data as the operand of the predetermined operation.

Next, the payment server 300 performs the mapping operation, in which a hash value that is mapped on the resultant value that is derived through the merge operation using a hash function is set as a new payment device token or a new user token. In particular, in the case of updating the payment device token and in the case of updating the user token, the payment server 300 may perform the mapping operation by differently performing the hash function.

The payment server 300 transmits the result of payment execution that is performed at S407 and the payment device token that is updated at S409 to the payment device 200 through the network 500 (S411).

Further, the payment server 300 transmits a payment success/failure message that includes the result of the payment execution that is performed at S407 to the mobile device 100 (S413). Here, if the payment is approved at S407, the payment execution result may include a phrase indicating that the payment has been approved and deposit balance after the payment, whereas if the payment is rejected, the payment execution result may include a phrase indicating that the payment has been rejected and a phrase indicating the reason of the rejection. In particular, at S407, the payment server 300 may transmit the payment success/failure message to the mobile device 100 through a messaging server 400, but is not limited thereto. The payment server 300 may directly transmit the payment success/failure message to the mobile device 100.

If the payment device token included in the payment request data does not match with the payment device token stored in the payment server, or if the user token included in the payment request data does not match with the user token stored in the payment server 300 as the result of the determination at S405, the payment server 300 determines that the payment request of the mobile device 100 is a double-payment request and performs the followings.

The payment server 300 rejects payment (S415). In particular, the payment rejection according to the payment execution at S407 is a payment rejection that occurs in the case where one or more of conditions for establishing transactions, such as deposit balance of a user account of the mobile device 100, effectiveness of a transaction means, and effectiveness of a transaction time, whereas the payment rejection at S415 is a payment rejection according to a double-payment request of a copied mobile device. Accordingly, the payment rejection at S407 and the payment rejection at S415 can be discriminated from each other.

The payment server 300 identifies the mobile device 100 of which the payment has been rejected using the update list for the user token (S417). Here, the update list for the user token is a list in which the user token that is updated after the payment execution is accumulatively stored. More specifically, the payment server 300 may search for the user token that is included in the payment request data in the update list, and identify the mobile device that is authenticated using the user token for which the searched token is finally updated as the mobile device of which the payment has been rejected.

Further, the payment server 300 transmits a warning message to the mobile device that is identified at S417 (S419). Here, the warning message may include a phrase indicating that the user token is double-spent. In particular, at S417, the payment server 300 may transmit the warning message through the messaging server 400, but is not limited thereto. The payment server 300 may directly transmit the warning message to the mobile device 100.

If the payment is requested from the payment device 200, the payment server 300 according to an embodiment of the present invention may newly update the payment device token and the user token that are stored in the payment server 300. Accordingly, even if the mobile device 100 is copied, the user token of the copied mobile device that has requested the double spending is different from the user token of the original mobile device, and thus it becomes possible to reject the double-payment approval. Further, since the warning message is transmitted through identification of the mobile device for which the payment has been rejected, it becomes possible to inform the user of the mobile device 100 that the corresponding mobile 100 has been copied.

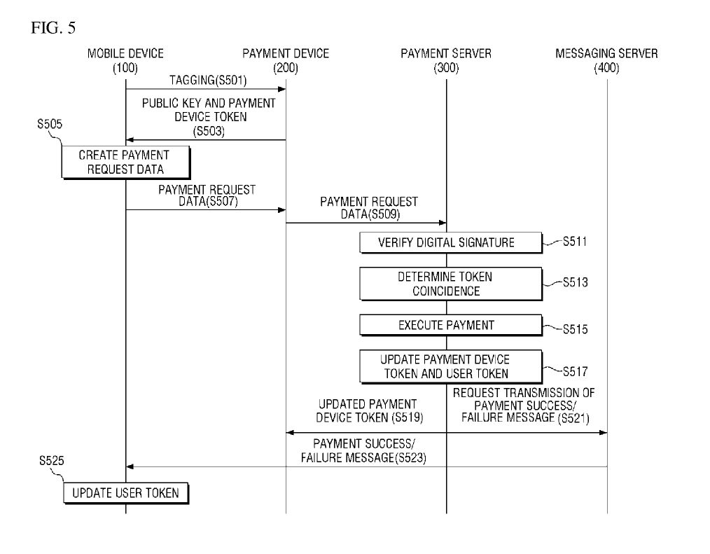

Hereinafter, a signal flow among the mobile device 100, the payment device 200, the payment server 300, and the messaging server 400 for performing the method for payment using the token according to an embodiment of the present invention will be described in detail with reference to FIGS. 5 to 7.

FIG. 5 is a signal flowchart explaining a method for payment using a mobile device 100 according to an embodiment of the present invention.

Referring to FIG. 5, if a user of a mobile device 100 requests payment from a device 200 for payment through NFC tagging (S501), the payment device 200 transmits a public key and a payment device token that is stored in the payment device 200 to the mobile device 100 using NFC (S503).

The mobile device 100 creates a digital signature through encrypting the payment device token that is received at S503 and a user token that is stored in the mobile device 100 using the public key that is received at S503, and creates payment request data that includes the created digital signature (S505). In particular, the mobile device 100 may encrypt a time stamp that indicates a payment request time using the public key that is received at S503 and make the encrypted time stamp further included in the digital signature.

The mobile device 100 transmits the payment request data that is created at S505 to the payment device 200 (S507). Preferably, the mobile device 100 transmits the payment request data using the NFC, but is not limited thereto. The mobile device 100 may also transmit the payment request data through a network 500.

The payment device 200 transmits the payment request data that is received at S507 to a payment server 300 through a network 500 (509).

The payment server 300 verifies a digital signature that is included in payment request data received at S509 using a private key (S511). Here, the private key is a key that has reciprocal relation to the public key that is used by the mobile device 100 to encrypt the payment device token and the user token.

The payment server 300 determines whether the payment device token and the user token, which are included in the payment request data that is received at S509, respectively match with the payment device token and the user token, which are stored in the payment server 300 (S513).

If the payment device token included in the payment request data matches with the payment device token stored in the payment server 300 and the user token included in the payment request data matches with the user token stored in the payment server 300 as the result of the determination at S513, the payment server 300 executes payment (S515). Here, the payment server 300 may approve or reject the payment through collective determination of conditions for establishing transactions, such as deposit balance of a user account of the mobile device 100, effectiveness of a transaction means, and effectiveness of a transaction time.

The payment server 300 updates the payment device token and the user token that are stored in the payment server 300 through performing of a token update operation (S517). In particular, according to another embodiment of the present invention, the payment server 300 may store the user token in an update list before performing S517.

At S517, the token update operation that is performed by the payment server 300 to update the payment device token and the user token is composed of a merge operation and a mapping operation. The merge operation and the mapping operation that are performed by the payment server 300 are as follows.

The payment server 300 performs the merge operation for deriving one resultant value through performing of a predetermined operation with the payment device token and the user token as operands. In particular, in the case of updating the payment device token and in the case of updating the user token, the payment server 300 may perform the merge operation by differently performing the predetermined operation as described above.

Further, in the case where the time stamp is further included in the payment request data that is received at S509, the payment server 300 may perform the merge operation further using the time stamp that is included in the payment request data as the operand of the predetermined operation.

Next, the payment server 300 performs the mapping operation, in which a hash value that is mapped on the resultant value that is derived through the merge operation using a hash function is set as a new payment device token or a new user token. In particular, in the case of updating the payment device token and in the case of updating the user token, the payment server 300 may perform the mapping operation by differently performing the hash function.

The payment server 300 transmits the result of payment execution that is performed at S515 and the payment device token that is updated at S517 to the payment device 200 through the network 500 (S519), and requests a messaging server 400 to transmit a payment success/failure message that includes the result of payment execution that is performed at S515 to the mobile device 100 (S521).

The messaging server 400 transmits the payment success/failure message to the mobile device 100 in response to the request at S521 (S523).

Further, the mobile device 100 updates the user token that is stored in the mobile device 100 through performing of a token update operation (S525). Here, the token update operation is performed in the same manner as the token update operation that is performed by the payment server to update the user token at S517.

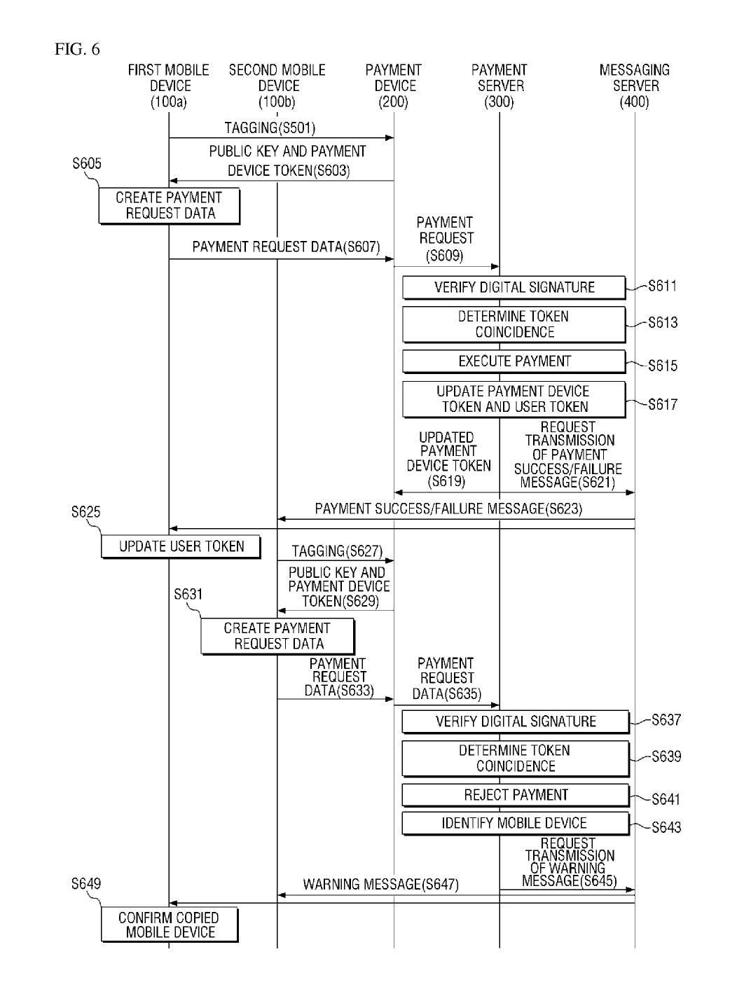

Prior to an explanation with reference to FIGS. 6 and 7, it is assumed that a first mobile device 100a that is explained with reference to FIGS. 6 and 7 is the original mobile device of a second mobile device 100b, and the second mobile device 100b is a copied mobile device of the first mobile device 100a.

FIG. 6 is a signal flowchart in the case where a first mobile device 100a makes prepayment according to an embodiment of the present invention.

Referring to FIG. 6, if a user of a first mobile device 100a requests first payment from a device 200 for payment through NFC tagging (S601), the payment device 200 transmits a public key and a first payment device token that is stored in the payment device 200 to the first mobile device 100a using NFC (S603).

The first mobile device 100a creates a digital signature through encrypting the first payment device token that is received at S603 and a first user token that is stored in the first mobile device 100a using the public key that is received at S603, and creates payment request data that includes the created digital signature (S605).

The first mobile device 100a transmits the payment request data that is created at S605 to the payment device 200 (S607).

The payment device 200 transmits the payment request data that is received at S607 to a payment server 300 through a network 500 (S609).

The payment server 300 verifies a digital signature that is included in payment request data received at S609 using a private key (S611).

The payment server 300 determines whether the first payment device token and the first user token, which are included in the payment request data that is received at S609, respectively match with the first payment device token and the first user token, which are stored in the payment server 300 (S613).

If the first payment device token included in the payment request data matches with the first payment device token stored in the payment server 300 and the first user token included in the payment request data matches with the first user token stored in the payment server 300 as the result of the determination at S613, the payment server 300 executes payment (S615).

The payment server 300 updates the first payment device token and the first user token that are stored in the payment server 300 to a second payment device token and a second user token through performing of a token update operation (S617). In particular, according to another embodiment of the present invention, the payment server 300 may store the first user token in an update list before performing S617.

The payment server 300 transmits the result of payment execution that is performed at S615 and the second payment device token that is updated at S617 to the payment device 200 through the network 500 (S619), and requests a messaging server 400 to transmit a payment success/failure message that includes the result of payment execution that is performed at S615 to the first mobile device 100a (S621).

The messaging server 400 intends to transmit the payment success/failure message to the first mobile device 100a. However, since a register identifier of the copied second mobile device 100b is equal to a register identifier of the first mobile device 100a, the messaging server 400 transmits the payment success/failure message to the first mobile device 100a and the second mobile device 100b (S623).

The first mobile device 100a updates the first user token that is stored in the first mobile device 100a to a first user token through performing of a token update operation (S625).

Further, if a user of a second mobile device 100b requests second payment from the payment device 200 through the NFC tagging (S627), the payment device 200 transmits a public key and a second payment device token that is updated at S617 to the second mobile device 100b using the NFC (S629).

The second mobile device 100b creates a digital signature through encrypting the second payment device token that is received at S629 and the non-updated first user token that is stored in the second mobile device 100b using the public key that is received at S629, and creates payment request data that includes the created digital signature (S631).

The second mobile device 100b transmits the payment request data that is created at S631 to the payment device 200 (S633).

The payment device 200 transmits the payment request data that is received at S633 to a payment server 300 through a network 500 (S635).

The payment server 300 verifies the digital signature that is included in the payment request data received at S635 using the private key (S637).

The payment server 300 determines whether the second payment device token and the first user token, which are included in the payment request data that is received at S635, respectively match with the second payment device token and a second user token, which are stored in the payment server 300 (S639).

Since the first user token included in the payment request data does not match with the second user token stored in the payment server 300 as the result of the determination at S639, the payment server 300 rejects the payment (S641).

The payment server 300 identifies that the mobile device for which the payment has been rejected is the first mobile device 100a using the update list for the user token (S643).

The payment server 300 requests the messaging server 400 to transmit a warning message to the first mobile device 100a that is identified at S643 (S645). Here, the warning message may include a phrase indicating that the user token is double-spent.

The messaging server 400 intends to transmit the warning message to the first mobile device 100a. However, since the register identifier of the copied second mobile device 100b is equal to the register identifier of the first mobile device 100a, the messaging server 400 transmits the warning message to the first mobile device 100a and the second mobile device 100b (S647).

Further, the first mobile device 100a can confirm that the first mobile device 100a has been copied through reception of the warning message including the phrase indicating that the user token has been double-spent (S649).

FIG. 7 is a signal flowchart in the case where a first mobile device 100a makes post-payment according to an embodiment of the present invention.

Referring to FIG. 7, if a user of a second mobile device 100b requests first payment from a device 200 for payment through NFC tagging (S701), the payment device 200 transmits a public key and a first payment device token that is stored in the payment device 200 to the second mobile device 100b using NFC (S703).

The second mobile device 100b creates a digital signature through encrypting the first payment device token that is received at S703 and a first user token that is stored in the second mobile device 100b using the public key that is received at S703, and creates payment request data that includes the created digital signature (S705).

The second mobile device 100b transmits the payment request data that is created at S705 to the payment device 200 (S707).

The payment device 200 transmits the payment request data that is received at S707 to a payment server 300 through a network 500 (S709).

The payment server 300 verifies a digital signature that is included in payment request data received at S709 using a private key (S711).

The payment server 300 determines whether the first payment device token and the first user token, which are included in the payment request data that is received at S709, respectively match with the first payment device token and the first user token, which are stored in the payment server 300 (S713).

If the first payment device token included in the payment request data matches with the first payment device token stored in the payment server 300 and the first user token included in the payment request data matches with the first user token stored in the payment server 300 as the result of the determination at S713, the payment server 300 executes payment (S715).

The payment server 300 updates the first payment device token and the first user token that are stored in the payment server 300 to a second payment device token and a second user token through performing of a token update operation (S717).

The payment server 300 transmits the result of payment execution that is performed at S715 and the second payment device token that is updated at S717 to the payment device 200 through the network 500 (S719), and requests a messaging server 400 to transmit a payment success/failure message that includes the result of payment execution that is performed at S715 to the second mobile device 100b (S721).

The messaging server 400 intends to transmit the payment success/failure message to the second mobile device 100b. However, since a register identifier of the original first mobile device 100a is equal to a register identifier of the second mobile device 100b, the messaging server 400 transmits the payment success/failure message to the first mobile device 100a and the second mobile device 100b (S723).

The second mobile device 100b updates the first user token that is stored in the second mobile device 100b to the second user token through performing of the token update operation (S725).

Further, the first mobile device 100a can confirm that the first mobile device 100a has been copied through reception of the payment success/failure message according to the payment request that the first mobile device 100a does not request at S723 (S727).

The method for payment according to the embodiments of the present invention as described above with reference to FIGS. 1 to 7 may be performed through execution of a computer program that is implemented by a computer readable code on a computer readable medium. The computer readable medium may be, for example, a movable recording medium (CD, DVD, blu-ray disc, USB storage device, or movable hard disc) or a fixed recording medium (ROM, RAM, computer-embedded hard disc). The computer program recorded on the computer readable recording medium may be transmitted from a first computing device to a second computing device through a network, such as Internet to be installed in the second computing device, and thus can be used in the second computing device. The first computing device or the second computing device may include a server device, a fixed computing device such as a desktop, a laptop, a smart phone, a mobile computing device such as a tablet, and a wearable computing device such as a smart watch or smart glasses.

Hereinafter, the logical configuration of the mobile device 100, the payment device 200, and the payment server 300 according to an embodiment of the present invention will be described in detail with reference to FIGS. 8 to 11.

FIG. 8 is a diagram illustrating the logical configuration of a mobile device 100 according to an embodiment of the present invention.

Referring to FIG. 8, a mobile device 100 may include a mobile device communication unit 102, a mobile device storage unit 104, a payment request data creation unit 106, and a user token update unit 108.

The mobile device communication unit 102 may transmit/receive data with a device 200 for payment using NFC, and transmit/receive data with the payment device 200, a payment server 300, and a messaging server 400.

The mobile device storage unit 104 is configured to store data that is necessary for the operation of the mobile device 100 together with a user token.

The payment request data creation unit 106 creates a digital signature through encrypting a payment device token that is received through the mobile device communication unit 120 and a user token that is stored in the mobile device storage unit 104 using a public key that is received through the mobile device communication unit 102, and creates payment request data that includes the created digital signature. Further, the mobile device 100 transmits the created payment request data to the payment device 200 through the mobile device communication unit 102.

If receiving a payment success/failure message through the mobile device communication unit 102, the user token update unit 108 updates the user token that is stored in the mobile device storage unit 104 through performing of a token update operation.

Specifically, the token update operation that is performed by the user token update unit 108 to update the user token is composed of a merge operation and a mapping operation.

More specifically, the user token update unit 108 performs the merge operation for deriving one resultant value through performing of a predetermined operation using the payment device token and the user token. Here, the predetermined operation may be a binary operation, such as addition, subtraction, multiplication, or division, in which the payment device token and the user token are considered as operands, but is not limited thereto. Further, the user token update unit 108 may further use a time stamp as an operand in performing the predetermined operation.

Further, the user token update unit 108 performs the mapping operation, in which a hash value that is mapped on the resultant value that is derived through the merge operation using a hash function is set as a new user token. Here, the hash function may use a secure hash algorithm, such as SHA-0, SHA-1, SHA-256, or SHA-512, but is not limited thereto.

FIG. 9 is a diagram illustrating the logical configuration of a device 200 for payment according to an embodiment of the present invention.

Referring to FIG. 9, a device 200 for payment may include a payment device communication unit 202, a payment device storage unit 204, a payment device token providing unit 206, a payment request data transfer unit 208, and a payment device token update unit 210.

The payment device communication unit 202 may transmit/receive data with a mobile device 100 using NFC, and transmit/receive data with the mobile device 100, a payment server 300, and a messaging server 400.

The payment device storage unit 204 is configured to store data that is necessary for the operation of the payment device 200 together with a public key and a payment device token.

If NFC tagging is sensed through the payment device communication unit 202, the payment device token providing unit 206 transmits the public key and the payment device token that is stored in the payment device storage unit 204 through the payment device communication unit 202.

If the payment request data is received through the payment device communication unit 202, the payment request data transfer unit 208 transmits the received payment request data to the payment server 300 through the payment device communication unit 202. In particular, the payment request data transfer unit 208 may additionally transmit additional data that is required for payment execution of the payment server 300.

If the updated payment device token is received through the payment device communication unit 202, the payment device token update unit 210 updates the payment device token through replacement of the payment device token stored in the payment device storage unit 204 by the received payment device token.

FIG. 10 is a diagram illustrating the logical configuration of a payment server 300 according to an embodiment of the present invention.

Referring to FIG. 10, a payment server 300 may include a payment server communication unit 302, a payment server storage unit 304, an illegal payment determination unit 306, a payment execution unit 308, and a token update unit 310.

The payment server communication unit 302 may transmit/receive data with a mobile device 100, a device 200 for payment, and a messaging server 400 through a network 500. In particular, the payment server communication unit 302 may directly transmit/receive data with the messaging server 400 without passing through the network 500.

The payment server storage unit 304 is configured to store data that is necessary for the operation of the payment server 300 together with a private key, a payment device token, a user token, and an update list for the user token. Here, the update list for the user token is a list in which the user token that is updated through the token update unit 310 is accumulatively recorded.

The illegal payment determination unit 306 verifies a digital signature included in payment request data that is received through the payment server communication unit 302 using the private key. Further, the illegal payment determination unit 306 determines whether the payment device token and the user token, which are included in the payment request data that is received through the payment server communication unit 302, respectively match with the payment device token and the user token, which are stored in the payment server storage unit 304.

Specifically, if the payment device token included in the payment request data matches with the payment device token stored in the payment serve storage unit 304 and the user token included in the payment request data matches with the user token stored in the payment server storage unit 304, the illegal payment determination unit 306 determines that the payment is not an illegal payment. Further, if the payment device token included in the payment request data does not match with the payment device token stored in the payment serve storage unit 304, or the user token included in the payment request data does not match with the user token stored in the payment server storage unit 304, the illegal payment determination unit 306 determines that the payment is an illegal payment.

If it is determined that the payment is an illegal payment, the illegal payment determination unit 306 identifies the mobile device 100 that has requested the illegal payment using the update list for the user token included in the payment server storage unit 304. More specifically, the illegal payment determination unit 306 may search for the user token that is included in the payment request data in the update list, and identify the mobile device that is authenticated using the user token for which the searched token is finally updated as the mobile device of which the payment has been rejected.

Further, the illegal payment determination unit 306 transmits a warning message to the mobile device 100 that is identified through the payment server communication unit 302.

The payment execution unit 308 executes the payment according to the payment request from the mobile device 100. Here, the payment execution unit 308 may approve or reject the payment through collective determination of conditions for establishing transactions, such as deposit balance of a user account of the mobile device 100, effectiveness of a transaction means, and effectiveness of a transaction time.

If the payment is executed through the payment execution unit 308, the token update unit 310 updates the payment device token and the user token that are stored in the payment server storage unit 304 through performing of a token update operation. In particular, according to another embodiment of the present invention, the token update unit 310 may store the user token in the update list before updating the user token.

Specifically, the token update operation that is performed by the token update unit 310 to update the user token is composed of a merge operation and a mapping operation. The merge operation and the mapping operation that are performed by the token update unit 310 are as follows.

The token update unit 310 performs the merge operation for deriving one resultant value through performing of a predetermined operation using the payment device token and the user token. Here, the predetermined operation may be a binary operation, such as addition, subtraction, multiplication, or division, in which the payment device token and the user token are considered as operands, but is not limited thereto. In particular, in the case of updating the payment device token and in the case of updating the user token, the token update unit 310 may perform the merge operation by differently performing the predetermined operation.

Further, in the case where a time stamp is further included in payment request data, the token update unit 310 may perform the merge operation further using the time stamp that is included in the payment request data as the operand of the predetermined operation.

Next, the token update unit 310 performs the mapping operation, in which a hash value that is mapped on the resultant value that is derived through the merge operation using a hash function is set as a new payment device token or a new user token. In particular, in the case of updating the payment device token and in the case of updating the user token, the token update unit 310 may perform the mapping operation by differently performing the hash function.

Up to now, respective constituent elements of FIGS. 8 to 10 may mean software or hardware, such as FPGA (Field-Programmable Gate Array) or ASIC (Application-Specific Integrated Circuit). However, the above-described constituent elements are not limited to the software or hardware, but may be configured to be in an addressable storage medium, or may be configured to execute one or more processors. Functions provided in the constituent elements may be implemented by sub-divided constituent elements, or may be implemented by one constituent element that performs a specific function through addition of a plurality of constituent elements.

The configuration of a mobile device 100, a device 200 for payment, and a payment server 300 according to still another embodiment of the present invention will be described with reference to FIG. 11.

FIG. 11 is a diagram illustrating the logical configuration of a mobile device 100, a payment device 200, and a payment server according to another embodiment of the present invention.

A mobile device 100 may include a processor 610 that performs a command, a storage 630 in which computer program data that implements a method for payment is stored, a memory 620, a network interface 640 for data transmission/reception with an external device, and a data bus 650 connected to the processor 610, the memory 620, the storage 630, and the network interface 640 to serve as a data movement path. In the storage 630, data, such as execution files for executing the computer program and resource files, may be stored.

Further, the payment device 200 and the payment server 300 may also include a processor, a memory, a storage, a network interface, and a data bus in the same manner as the mobile device 100.

The foregoing is illustrative of the present invention and is not to be construed as limiting thereof. Although a few embodiments of the present invention have been described, those skilled in the art will readily appreciate that many modifications are possible in the embodiments without materially departing from the novel teachings and advantages of the present invention.

Accordingly, all such modifications are intended to be included within the scope of the present invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. A method for payment comprising:
receiving, from a payment device, a public key and a payment device token;
generating a digital signature by encrypting, using the public key, the received payment device token and a stored user token;
generating payment request data comprising the generated digital signature;
transmitting, to the payment device, the generated payment request data; and
updating the stored user token.

2. The method of claim 1, wherein the updating the stored user token comprises:
performing a predetermined operation in which the payment device token and the user token are operands; and
updating the user token using a hash value that is mapped on a resultant value of the performed predetermined operation.

3. The method of claim 2, wherein the predetermined operation further comprises, as another operand, a time stamp that indicates a payment request time, and
the digital signature further comprises the time stamp that is encrypted using the public key.

4. The method of claim 1, wherein the updating the stored user token comprises:
receiving a payment message indicating one of payment success and payment failure; and
in response to the receiving the payment message, updating the stored user token.

5. A method for payment comprising:
receiving, from a first mobile device, a first payment request;
in response to the receiving the first payment request, transmitting, to the first mobile device, a public key and a first payment device token;
receiving, from the first mobile device, payment request data;
transmitting, to a payment server, the received payment request data;
in response to the transmitting the payment request data, receiving, from the payment server, a second payment device token and replacing the first payment device token with the second payment device token;
receiving, from one of the first mobile device and a second mobile device, a second payment request; and
in response to the receiving the second payment request, transmitting, to said one of the first mobile device and the second mobile device from which the second payment request is received, the public key and the second payment device token.

6. A method for payment comprising:
receiving, from a payment device, payment request data comprising a digital signature which is generated based on a first payment device token and a first user token;
verifying the digital signature using a private key;
determining whether the first payment device token and the first user token match with a second payment device token and a second user token, respectively;
in response to the determining indicating that the first payment device token and the first user token match with the second payment device token and the second user token, respectively, executing payment; and
updating the second payment device token and the second user token by performing a token update operation in response to the first payment device token and the first user token matching with the second payment device token and the second user token, respectively.

7. The method of claim 6, wherein the executing the payment further comprises in response to at least one of: the first payment device token not matching with the second payment device token and the first user token not matching with the second user token, rejecting the payment.

8. The method of claim 7, wherein the updating the second user token comprises updating the second user token after storing the second user token in an update list in which the second user token is accumulatively recorded.

9. The method of claim 8, wherein the rejecting the payment further comprises:
identifying a rejected mobile device for which the payment has been rejected using the update list; and
transmitting a warning message to the identified mobile device.

10. The method of claim 9, wherein the identifying the mobile device comprises:
searching for the first user token in the update list; and
identifying the rejected mobile device as a mobile device that last authenticated using the first user token according to the update list.

11. The method of claim 6, wherein the token update operation performs a predetermined operation in which the first payment device token and the first user token are operands, and updates the first user token using a hash value that is mapped on a resultant value of the predetermined operation.

12. A method for payment comprising:
transmitting, from a payment device to a mobile device, a public key and a first payment device token;
generating, by the mobile device, a digital signature by encrypting the first payment device token and a first user token using the public key; and
generating, by the mobile device, a payment request data comprising the generated digital signature;
transmitting, to a payment server, the generated payment request data; and
verifying, at the payment server, the digital signature using a private key, and determining whether the first payment device token and the first user token match with a second payment device token and a second user token, respectively;
executing, at the payment server, a payment in response to determining indicating that the first payment device token and the first user token match with the second payment device token and the second user token, respectively, and updating the second payment device token to a third payment device token and the second user token to a third user token through a token update operation;
receiving, at the payment device, the third payment device token from the payment server, and replacing the first payment device token with the third payment device token; and
updating, at the mobile device, the first user token through the token update operation.

13. A system for payment comprising:
a mobile device configured to generate a digital signature by encrypting a first payment device token and a first user token using a received public key, generate payment request data comprising the generated digital signature, and update the first user token through a token update operation;
a payment device configured to transmit, to the mobile device, the public key and the first payment device token, receive, from the mobile device, the payment request data, receive a third payment device token, and replace the first payment device token with the third payment device token; and
a payment server configured to receive, from the payment device, the payment request data, verify the digital signature using a private key, determine whether the first payment device token and the first user token match with a second payment device token and a second user token, respectively, execute payment, in response to the determining indicating that the first payment device token and the first user token match with the second payment device token and the second user token, respectively, and update the second payment device token to the third payment device token and the second user token to a third user token through the token update operation.

14. The system of claim 13, further comprising a messaging server configured to transmit, to the mobile device, in response to a request received from the payment server, one of a payment message indicating one of payment success and payment failure and a warning message.
